(19) United States
(12) Patent Application Publication
(10) Pub. No.: US 2007/0183372 A1
(43) Pub. Date: Aug. 9, 2007

(54) Accelerated establishment of a connection between a number of mobile radio users

(75) Inventors: Otto Janko, Wien (AT); Olaf Kautz, Berlin (DE); Gerhard Kieselmann, Munchen (DE); Peter Kim, Berlin (DE); Ralf Munninghoff, Erding (DE); Roland Steiner, Wien (AT)

Correspondence Address: MORRISON & FOERSTER LLP, 1650 TYSONS BOULEVARD, SUITE 400, MCLEAN, VA, 22102, US

(73) Assignee: SIEMENS AKTIENGESELLSCHAFT, MUNCHEN (DE)

(21) Appl. No.: 10/564,517

(22) PCT Filed: Jul. 16, 2004
(86) PCT No.: PCT/EP04/51517

§ 371 Date: Nov. 16, 2006

(30) Foreign Application Priority Data
Jul. 17, 2003 (DE) 10332746.0

(51) Int. Cl. H04B 7/216

(52) U.S. Cl. 370/335; 370/401; 370/474

(57) ABSTRACT

Disclosed is a method which allows for a fast and efficient establishment of a connection between members of a group, more specifically between a mobile radio user who triggers the establishment of the connection and additional mobile radio users of a group of mobile radio users via at least one mobile radio network. According to the inventive method, a first channel that can be used for transmitting signaling data is set up when establishing the connection. User data, such as language, which is to be transmitted between the mobile radio user triggering the establishment of the connection and other members of the group is also transmitted via said channel in addition to the signaling data until a second channel is also set up for the connection, whereupon user data is transmitted via the second channel.

### CLAIM FOR PRIORITY

This application is a national stage of PCT/EP2004/051517 which was published on Jan. 27, 2005 and which claims the benefit of priority to German Application No. 10332746.0 filed Jul. 17, 2003.

### TECHNICAL FIELD OF THE INVENTION

The invention relates to methods and devices for establishing a connection between a mobile radio user initiating establishment of the connection and a further mobile radio user or further mobile radio users from a group of mobile radio users.

### BACKGROUND OF THE INVENTION

WO 02/085050 discloses the transmission of useful data via a useful data channel.

“Digital Cellular Telecommunications System (Phase 2+), Universal Mobile Telecommunication System (UMTS), General Packet Radio Service (GPRS) Service Description, Stage 2 (3GPPTS 23.060 version 5.2.0 release 5)” ETSI TS 123060 V5.5.0 discloses the provision of a second PDP context with a different QUS profile in addition to an existing RTP context between two users.

The invention relates to services, for which connections have to be established as quickly as possible, for example a so-called push to talk service for a mobile radio network, in which a mobile radio user can initiate a connection to predefined (and also currently available) members of a group of mobile radio users (and in some instances also fixed-network users) by means of an input, for example pushing a button, at their mobile station.

Such connections can be established in different mobile radio networks, such as GSM/CDMA/TDMA/WCDMA/TDCCMA/TDCSMA/4G mobile radio networks. Members of a group can also be mobile radio users, who communicate via different mobile radio networks and radio interfaces with the other members of the group.

To establish such a connection, a channel used for the transmission of signaling data can be established in the form of a PDP context between a member of the group and a mobile radio network for the transmission of signaling data and a voice channel in the form of a further PDP context can be established for the transmission of voice data between the mobile radio terminal and a mobile radio network. Signaling for session control purposes (including connection establishment and processing) can take place via the PDP context provided for signaling. The voice channel in the form of a further PDP context can transmit voice data between at least one mobile radio user and a mobile radio network (for forwarding to the other mobile radio users of a group) respectively. The PDP context to be provided for transmitting voice data can be of better quality (in respect of delay and/or loss rate).

### SUMMARY OF THE INVENTION

The object of the present invention is to allow uninterrupted establishment of a connection between a mobile radio user and members of a group in the simplest and most efficient manner possible via at least one mobile radio network further to an input by a mobile radio user in the group (in particular push to talk). The object is achieved by the subject matter of the independent claims respectively.

Since according to the invention voice data is transmitted between a mobile radio user and a mobile radio network first via a useful data channel also used for the transmission of signaling data (first PDP context), until a further useful channel (second PDP context) is established between this user and the mobile radio network, whereupon voice data is transmitted via the second useful channel, the transmission of voice data can be accelerated in a simple and efficient manner during the establishment of a connection between the mobile radio user and the mobile radio network for a push to talk service, as the user can first talk via. the (already established) useful data channel used for the transmission of signaling data, so that delays are avoided before establishment of the voice channel (which can be more complex, in particular if negotiations are required in respect of resources and/or codecs).

In some mobile radio networks such a method could be implemented just by means of a modification in the mobile radio terminal of a user, which transmits useful data (e.g. voice data, streaming video data or data for interactive applications) first via a first channel used for the transmission of signaling data (first PDP context) and, when a second channel (second PDP context) has been established, transmits the useful data via the second channel (optionally informing the mobile radio network and/or receiving mobile radio terminals of this). If a mobile radio terminal, which can according to the invention for example transmit voice data first via a first channel used for the transmission of signaling data, calls a member of a group, whose mobile radio terminal cannot do this, the mobile radio network can send voice data to be transmitted to the further mobile radio terminal (which can only receive voice data via a voice channel) via a PDP context provided (only) for voice transmission.

### BRIEF DESCRIPTION OF THE DRAWINGS

Further features and advantages of the invention will emerge from the claims and description which follows of an exemplary embodiment with reference to the drawing, in which:

FIG. 1 shows the claimed establishment of a connection between a mobile radio terminal and a mobile radio network and

FIG. 2 shows a schematic illustration of a specific example of the parties involved in a push to talk connection.

### DETAILED DESCRIPTION OF THE INVENTION

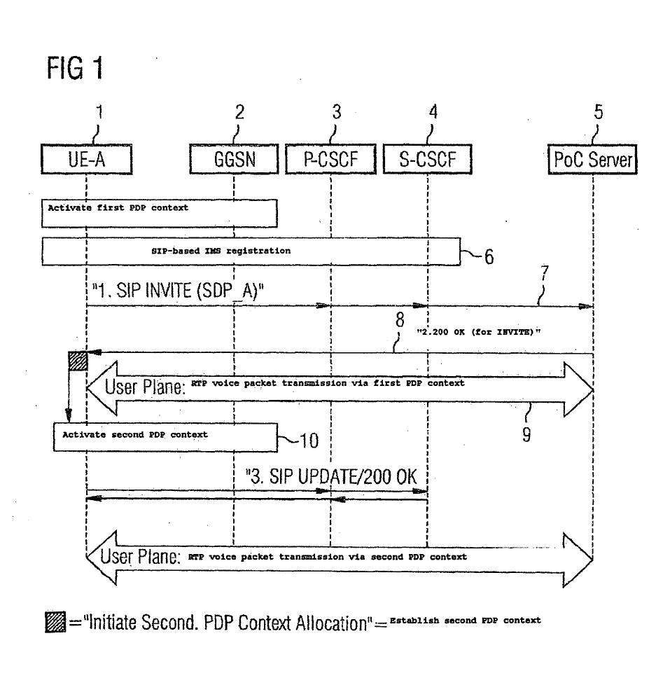

FIG. 1 shows a mobile radio terminal (UE-A) of a mobile radio user wishing to establish a connection between themselves (1) and further members 18, 19 of a group 1, 18, 19 of mobile radio users by means of a push to talk service (by means of an input such as pushing a button) and (at least) one switching arrangement in the form of a GGSN (2) of a mobile radio network (and control arrangements P-CSCF (3), S-CSCF (4) of a mobile radio network and a POC server) via useful data channels in PDP contexts (5, 10).

The mobile radio users (i.e. the mobile radio user identities in a mobile radio user identity card SIM, etc. or mobile radio terminals) that are members of a group can be stored in a mobile radio terminal (and can also be notified to at least one mobile radio network in the course of a connection) and/or stored in a mobile radio network. After an input, for example pushing a button, at a mobile radio terminal of a mobile user a connection can be established to the members of this group.

A first PDP context (5) is first activated between the mobile radio terminal (UE-Al) and a switching center (GGSN2) and SIP-based registration (6) takes place between the mobile radio terminal and a control arrangement S-CSCF (4) of a mobile radio network. After a mobile radio terminal UE-A (1) of a mobile radio user detects an input in respect of the requested establishment of a connection to one or more members of a group (e.g. a specific key is pushed for a push to talk service), it 1 sends a message (7) via a signaling channel (which does not have to correspond to the first PDP context) to a POC server (5) controlling the establishment of a connection between the users in a group (e.g. with a message “SIP invited (SIP_A)”).

The POC server 5 responds with a confirmation (8) (message “2.200 ok for invite”) to the mobile radio terminal 1. (At least) one more PDP context (10) than the one provided for the transmission of useful data is also established between a mobile radio terminal UE-A 1 and a switching arrangement (GGSN) (2) of a mobile radio network. This useful data can include voice, video or other data. However establishment of this second PDP context (10) takes longer than the immediate use of the already existing first PDP context (and/or is even not established until after the first PDP context), so that the second PDP context for the useful data is available later than the PDP context for the signaling data. Voice data for example is therefore first transmitted via the first channel used for the transmission of signaling data from a mobile radio terminal (1) (in the known manner via an air interface and base stations, etc.) to a switching arrangement (2) of a mobile radio network, until the second PDP context provided for the transmission of voice data has also been established.

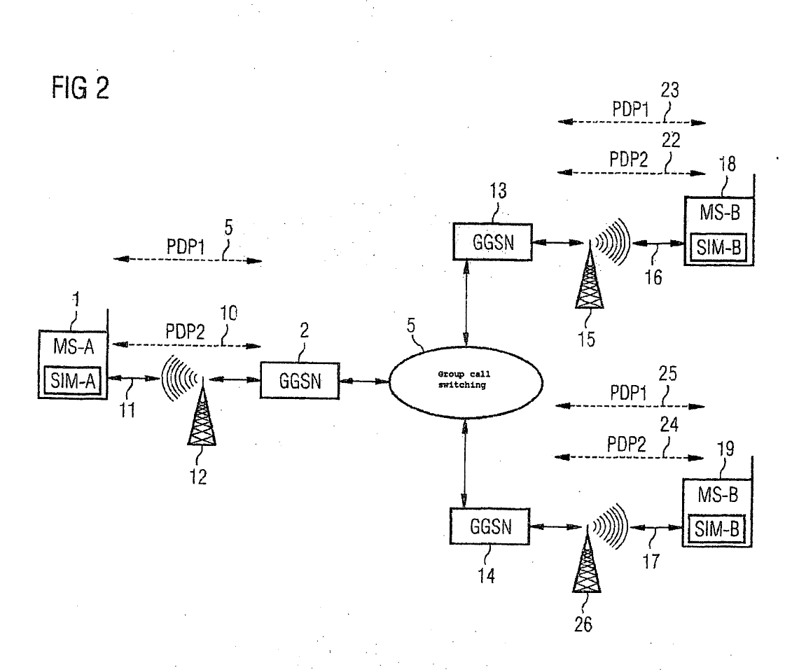

FIG. 2 shows a schematic illustration of data transmission during a group call.

The useful data is transmitted respectively between the mobile radio terminals (1) (with mobile radio user identity cards SIM, etc.) via an air interface (11) of a mobile radio network, base stations, etc. (12), switching arrangements (GGSN 2), further switching arrangements (in this instance GGSNs 13, 14), further base stations etc. (15, 26) and air interfaces (16, 17) to further mobile radio users (mobile radio stations 18, 19) of a group (1, 18, 19). Transmission between the switching arrangements (2, 13, 14) can take place directly, via GGSNs, SGSNs or group call switching systems (5). In the same way as voice data from the mobile station (1) of a user (as described above) is first transmitted via a more quickly established first PDP context (20) provided for signaling and then via a second PDP context (21) established later or more slowly but in some instances providing better quality, it is also possible for further members (18, 19) of a group of mobile radio users after the connection has been established for useful data (=useful data of a user) to be transmitted first via a more quickly established first useful data channel(first PDP context 23 or 25) and then, after a second (useful data) channel has been established for useful data (second PDP context 23 or 24), to be transmitted via a second channel 22, 24. In this manner a first useful data transmission will take place soon after activation even for the users MS-B, MS-C (18, 19) of the group after activation of a connection establishment (by users MS-A (1)=UE-A (1)).

What is claimed is:

1. Method for establishing a connection (5, 10) between a mobile radio user (1) initiating the establishment (5-10) of the connection (5, 10) and further mobile radio users (18, 19) of a group of mobile radio users via at least one mobile radio network (11, 12, 2, 13, 14, 15, 26, 16, 17), with useful data to be transmitted between the mobile radio user (1) initiating establishment of the connection and further members (18, 19) of the group also being transmitted in addition to signaling data (6) via a first channel (5) on establishment of the connection, until a second channel (10) is also established for the connection (5, 10), whereupon the user data is transmitted via the second channel (10).

2. Method according to claim 1, characterized in that the channel (5) used for the transmission of signaling data is a PDP context.

3. Method according to claim 1, characterized in that the second channel (e.g. the voice channel 10) is a further PDP context.

4. Method according to claim 1, characterized in that the first channel (5) used for the transmission of signaling data and/or the second channel (10) transmit(s) useful data in a packet-switched manner, in particular by GPRS, UMTS, etc.

5. Method according to claim 1, characterized in that the mobile radio network (12, 2, 13, 14, 15, 26) is a cellular mobile radio network.

6. Method according to claim 1, characterized in that the connection (5, 10) is established for mobile radio network services, requiring the fastest possible availability of useful data transmission, e.g. push to talk.

7. Method according to claim 1, characterized in that initiation of the establishment of the connection takes place on detection of an input at a mobile radio terminal of a mobile radio user (1), in particular when the pushing of a button is detected.

8. Method according to claim 1, characterized in that the first channel (5) used for the transmission of signaling data runs from a mobile station (1) of the mobile radio user initiating establishment of the connection to a switching center (2) of a mobile radio network.

9. Method according to claim 1, characterized in that the channel used for the transmission of signaling data runs from a mobile station via an SGSN and/or a GGSN.

10. Method according to claim 1, characterized in that the mobile radio users participating in the service are stored in a mobile radio network and/or a mobile radio terminal.

11. Method according to claim 1, characterized in that the connection is established such that useful data from every member of the group is transmitted to individual or all other members of the service.

12. Method according to claim 1, characterized in that useful data is transmitted between every member of the group and a mobile radio network first via a first channel (5, 23, 25) used for the transmission of signaling data and then via another channel (10, 23, 24), which could provide better transmission quality.

13. Method according to claim 1, characterized in that the first and/or second channel is/are a useful data channel.

14. Method according to claim 1, characterized in that once a second channel (10) is established, the useful data, e.g. voice data, is sent via the second channel (10).

15. Method according to claim 1, characterized in that the useful data is or contains voice data and/or streaming video data and/or data for interactive applications.

16. Device for implementing a method according to claim 1.

17. Mobile radio terminal (1), in particular according to claim 16, with
a controller, which is configured such that when a connection is established between the mobile radio terminal (1) and one or more mobile radio users of a group, it (1) first transmits voice data for example to a mobile radio network via a first channel (5) also used for the transmission of signaling data,
and ,once a second channel (10) is established, sends the voice data via the second channel (10).

18. Mobile radio terminal (I) according to claim 17, characterized in that once a second channel (10) is established, it sends the voice data via the second channel (10).

19. Mobile radio terminal (1) according to the preceding claim 18, characterized in that once a second channel (10) is established, it (1) can only send voice data via the second channel (10).
